(19) United States
(12) Patent Application Publication
(10) Pub. No.: US 2003/0013817 A1
(43) Pub. Date: Jan. 16, 2003

(54) High temperature ionic polymers and membranes made therefrom

(76) Inventor: Kelly Lu, Rosemead, CA (US)

Correspondence Address: Fulfill America, Inc., 8748 E. Valley Blvd., Suite # L, Rosemead, CA, 91770, US

(21) Appl. No.: 09/888,843

(22) Filed: Jun. 26, 2001

(51) Int. Cl. C08F 116/00

(52) U.S. Cl. 525/328.4; 525/328.5; 526/240; 526/287; 526/303.1; 526/317.1; 526/242

(57) ABSTRACT

A novel class of high temperature ion-containing poly(aromatic) polymers is disclosed. They are Poly(aryl amide(—CONH—), sulfonyl amide (—SO₂NH—), imide((—CO—)₂N—), imidazole ((—NH—)(—N═)C—), oxazoles ((—NH—)(—O—)C—), thiazoles ((—NH—)(—S—)C—), amino (—NH—) group, ether (—O—), sulfide (—S—), sulfone (—SO₂—), or some combination of them) and they contain at least one type of ionic functional group selected from the following:

(a) pendent ionic group:

-Q-SO₃(M), or

-Q-SO₂—N(M)—SO₂—R, or

—SO₂—N(M)—SO₂—R

(b) linking ionic group:

—SO₂—N(M)—SO₂—

-Q-SO₂—N(M)—SO₂—

-Q-SO₂—N(M)—SO₂-Q-

wherein Q is a fluorinated alkylene or fluorinated alkoxylene group with carbon number from 1 to 12, and R is a fluorinated alkyl or fluorinated alkoxy group with carbon number from 1 to 12. M can be hydrogen H, lithium Li, sodium, Na, potassium K, and other suitable metal ions or organic bases.

The new polymers can be random or blocked copolymers and can be crosslinked. The polymer can be made into polymeric membranes or composite membranes suitable for fuel cell, electrochemical applications, or selective permeable applications.

### FIELD OF THE INVENTION

This invention teaches a new class of high temperature aromatic polymers that contain fluoroalkylene or fluoroalkoxylene sulfonic acid or sulfonyl imide functionalities. The polymers are potentially suitable for making membranes or composite membranes or laminates for fuel cell and other electrochemical and selective permeable applications.

### BACKGROUND OF THE INVENTION

Several ionic polymers have been developed over the years for polymer electrolyte membrane (PEM) fuel cell or other electrochemical applications. The current state-of-the-art polyelectrolyte membrane is Nafion®, which is a perfluorinated copolymer with sulfonic acid side chain. It was commercialized by duPont in the 1960s and played a vital role in some electrochemical systems such as the chloroalkaline industry, due to the high hydrolytic stability and good conductivity. The copolymer compositions were described such as in U.S. Pat. Nos. 3,282,875 and 4,330,654. However, it has some limitation as a PEM, such as absorbed water is lost at temperatures greater than 80° C. which results in low conductivity. Methanol cross-over is also excess in direct methanol fuel cells. The perfluorinated polymers are also very expensive. Another class of fluoropolymers made from trifluorostyrene and substituted trifluorostyrene were described in U.S. Pat. Nos. 5,498,639 and 5,602,185. These copolymers have good mechanical properties as well as initial fuel cell performance; however, it is very difficult to obtain high yield of the copolymers. In addition, the sulfonic acid functionality directly linked to the aromatic ring does not give high hydrolytic stability and long term durability as compared to Nafion® perfluorinated copolymer. Polyimides and PEEK are high temperature polymers. Attempts of adding sulfonic acid groups on these polymers have been reported. However, they have the same problem as that of trifluorostyrene ionomers, wherein the sulfonic acid directly linked to the aromatic ring does not produce long term durability for electrochemical usage. It is very desirable to have an economical ionic polymer that could have high temperature and high hydrolytic stability and good conductivity and low methanol cross-over rate and good long term durability in use for electrochemical applications. DesMarteau disclosed in U.S. Pat. No. 5,463,005 some perfluorinated monomers containing non-oxy superacid groups —CF₂SO₂NHSO₂RF and —CF₂SO₂CH₂SO₂RF. However, these types of perfluorinated monomers are very expensive for industrial applications.

### SUMMARY OF THE INVENTION

This invention teaches a new class of high temperature ion-containing polymers that have the general molecular structure as follows:

[A₁-X₁-A₂-X₂]_{w}-[A₄-X₄-A₅-X₅-]_{y or}

-[A₃-X₃]_{w}-[A₆-X₆-]_{y}

or

-[A₃-X₃]_{w}-[A₄-X₄-A₅-X₅-]_{y}

or

-[A₁-X₁-A₂-X₂]_{w}-[A₆-X₆-]_{y}

wherein A₁, A₂, A₃, A₄, A₅ and A₆ are unsubstituted or inertly substituted aromatic hydrocarbyl or heterocyclic functional groups; “Inertly” means not participating in polymerization reaction. X₁, X₂, X₃, X₄, X₅ and X₆ are linking functional groups selected from [amide(—CONH—), sulfonyl amide (—SO₂NH—), imide((—CO—)₂N—), imidazole ((—NH—)(—N═)C—), oxazoles ((—NH—)(—O—)C—), thiazoles ((—NH—)(—S—)C—), amine (—NH—) group, ether (—O—), sulfide (—S—), sulfone (—SO₂—), or some combination of them]; w is from 0 to 90 molar %; y is from 10 to 100 molar %; while A₁, A₂ and A₃ do not contain any ionic functional group, A₆ and A₄ or A₅ must contain at least one ionic functional group selected from the following:

(a) pendent ionic group:

-Q-SO₃(M), or

-Q-SO₂—N(M)—SO₂—R, or

—SO₂—N(M)—SO₂—R

(b) linking ionic group:

—SO₂—N(M)—SO₂—

-Q-SO₂—N(M)—SO₂—P1 -Q-SO₂—N(M)—SO₂-Q-

wherein Q is a fluorinated alkylene or fluorinated alkoxylene group with carbon number from 1 to 12; R is a fluorinated alkyl or fluorinated alkoxy group with carbon number from 1 to 12; M can be hydrogen H, lithium Li, sodium, Na, potassium K, and other suitable metal ions. When A₆ and A₄ or A₅ contains the linking ionic group of (b), it contains at least 2 aromatic rings that connect to each side of the linking ionic group respectively.

The polymers of this invention can be prepared by polymerization reaction of the monomer mixture selected from:

0-90 molar % of [monomer pair of A₁ (Y₁)ₚ and A₂ (Y₂)_{q}] or

[self-condensing monomer A₃ (Y₁)ₚ (Y₂)_{q}]

10-100 molar % of [monomer pair of A₄ (Y₃)ₚ and A₅ (Y₄)_{q}] or

[self-condensing monomer A₆ (Y₃)ₚ (Y₄)_{q}]

wherein Y₁, Y₂, Y₃ and Y₄ are reactive functional groups that can chemically react with at least one another and are selected from [amine (—NH₂), anhydride ((—CO—)₂O), imide ((—CO—)₂NH), amide (—CONH₂), sulfonyl amide (—SO₂NH₂), carboxylic acid (—COOH), carboxylic acid ester, carboxylic acid halide, hydroxyl (—OH), thio (—SH), sulfonyl halide or halides, including halogen atoms such as F, Cl, Br, I]; p and q are integers from 1 to 4; A₁, A₂ and A₃ are unsubstituted or inertly substituted aromatic hydrocarbyl group or heterocyclic functional groups that do not contain any ionic functional group; A₄, A₅ and A₆ are unsubstituted or inertly substituted aromatic hydrocarbyl groups or heterocyclic functional groups in which A₆ and A₄ or A₅ must contain at least one ionic functional group selected from the following groups

(a) pendent ionic group:

-Q-SO₂F

-Q-SO₃(M), or

-Q-SO₂—N(M)—SO₂—R, or

—SO₂—N(M)—SO₂—R

(b) linking ionic group:

—SO₂—N(M)—SO₂—

-Q-SO₂—N(M)—SO₂—

-Q-SO₂—N(M)—SO₂-Q-

wherein Q is a fluorinated alkylene or fluorinated alkoxylene group with carbon number from 1 to 12; R is a fluorinated alkyl or fluorinated alkoxy group with carbon number from 1 to 12; M can be hydrogen H, lithium Li, sodium, Na, potassium K, and other suitable metal ions or organic bases. When A₆, A₄ or A₅ contains the linking ionic group of (b), it contains at least 2 aromatic rings that connect to each side of the linking ionic group respectively.

The said polymers can be random or blocked copolymers and can be crosslinked by irradiation or when trifunctional or tetrafunctional monomers are to be used or by other means. The polymerization reaction could occur in bulk, solution, emulsions, or in porous substrates such as microporous membranes. The polymeric membranes or composite membranes are suitable for fuel cell, electrochemical applications, or selective permeable applications.

### DETAILED DESCRIPTION OF THE INVENTION

High temperature ion-containing polymers of the invention are formed by chemical polycondensation reaction of monomers to produce aromatic poly (amide(—CONH—), sulfonyl amide (—SO₂NH—), imide((—CO—)₂N—), sulfonyl imide (—SO₂—NH—SO₂—), imidazole ((—NH—)(—N═)C—), oxazoles ((—NH—)(—O—)C—), thiazoles ((—NH—)(—S—)C—), amino (—NH—) group, ether (—O—), sulfide (—S—), sulfone (—SO₂—) and the like). “High temperature” is defined as having good thermal stability of less than 10% per hour of weight loss in air at 300° C. The term polymer include oligomers which have from 2 to about 100 monomer units and preferably have a molecular weight of from about 500 to about 30,000. It is within the scope of this invention to form lower molecular weight oligomers useful as fluids or prepolymers and higher molecular weight polymers thereafter. Higher molecular weight polymers have a molecular weight of from 30,000 to about 1,000,000.

This new class of high temperature ion-containing polymers have the basic 25 molecular backbone structure as follows:

-[A₁-X₁-A₂-X₂]_{w}-[A₄-X₄-A₅-X₅-]_{y}

or

-[A₃-X₃]_{w}-[A₆-X₆-]_{y}

or

-[A₃-X₃]_{w}-[A₄-X₄-A₅-X₅-]_{y}

or

-[A₁-X₁-A₂-X₂]_{w}-[A₆-X₆-]_{y}

wherein A₁, A₂, A₃, A₄, A₅ and A₆ are unsubstituted or inertly substituted aromatic hydrocarbyl or heterocyclic functional groups; “Inertly” means not participating in polymerization reaction. X₁, X₂, X₃, X₄, X₅ and X₆ are linking functional groups selected from [amide(—CONH—), sulfonyl amide (—SO₂NH—), imide((—CO—)₂N—), imidazole ((—NH—)(—N═)C—), oxazoles ((—NH—)(—O—)C—), thiazoles ((—NH—)(—S—)C—), amine (—NH—) group, ether (—O—), sulfide (—S—), sulfone (—SO₂—), or some combination of them]; w is from 0 to 90 molar %; y is from 10 to 100 molar %; while A₁, A₂ and A₃ do not contain any ionic functional group, A₆ and A₄ or A₅ must contain at least one ionic functional group selected from the following:

(a) pendent ionic group:

-Q-SO₃(M), or

-Q-SO₂—N(M)—SO₂—R, or

—SO₂—N(M)—SO₂—R

(b) linking ionic group:

—SO₂—N(M)—SO₂—

-Q-SO₂—N(M)—SO₂—

-Q-SO₂—N(M)—SO₂-Q-

wherein Q is a fluorinated alkylene or fluorinated alkoxylene group with carbon number from 1 to 12; R is a fluorinated alkyl or fluorinated alkoxy group with carbon number from 1 to 12; M can be hydrogen H, lithium Li, sodium, Na, potassium K, and other suitable metal ions or organic bases. When A₆ and A₄ or A₅ contains the linking ionic group of (b), it contains at least 2 aromatic rings that connect to each side of the linking ionic group respectively.

The polymers of this invention can be prepared by polymerization reaction of the monomer mixture selected from the following:

0-90 molar % of [monomer pair of A₁ (Y₁)ₚ and A₂ (Y₂)_{q}] or

[self-condensing monomer A₃ (Y₁)ₚ (Y₂)_{q}], and

10-100 molar % of [monomer pair of A₄ (Y₃)ₚ and A₅ (Y₄)_{q}] or

[self-condensing monomer A₆ (Y₃)ₚ (Y₄)_{q}]

wherein Y₁, Y₂, Y₃ and Y₄ are reactive functional groups that can chemically react with at least one another and are selected from [amine (—NH₂), anhydride ((—CO—)₂O), imide ((—CO—)₂NH), amide (—CONH₂), sulfonyl amide (—SO₂NH₂), carboxylic acid (—COOH), carboxylic acid ester, carboxylic acid halide, hydroxyl (—OH), thio (—SH), sulfonyl halide or halides, including halogen atoms such as F, Cl, Br, I]; p and q are integers from 1 to 4; A₁, A₂ and A₃ are unsubstituted or inertly substituted aromatic hydrocarbyl group or heterocyclic functional groups that do not contain any ionic functional group; A₄, A₅ and A₆ are unsubstituted or inertly substituted aromatic hydrocarbyl groups or heterocyclic functional groups in which A₆ and A₄ or A₅ must contain at least one ionic functional group selected from the following groups

(a) pendent ionic group:

-Q-SO₂F

-Q-SO₃(M), or

-Q-SO₂—N(M)—SO₂—R, or

—SO₂—N(M)—SO₂—R

(b) linking ionic group:

—SO₂—N(M)—SO₂—

-Q-SO₂—N(M)—SO₂—

-Q-SO₂—N(M)—SO₂-Q-

wherein Q is a fluorinated alkylene or fluorinated alkoxylene group with carbon number from 1 to 12; R is a fluorinated alkyl or fluorinated alkoxy group with carbon number from 1 to 12; M can be hydrogen H, lithium Li, sodium, Na, potassium K, and other suitable metal ions. When A₆, A₄ or A₅ contains the linking ionic group of (b), it contains at least 2 aromatic rings that connect to each side of the linking ionic group respectively.

The structure of A₁, A₂, A₃, A₄, A₅, and A₆ can be any molecular structures having aromatic character or heterocyclic functional groups, preferably having at least one five membered or six membered aromatic ring, or suitably having 2 to 6 of such rings fused together or connected by bonds or linking structures. For example, the aromatic molecular structure may include perchlorophenylene, perfluorophenylene, phenylene, biphenylene, oxydiphenylene, thiodiphenylene, phenyl sulfone, benzophenone, benzophenone imine, furan, pyridine, pyrrole, thiophene, 9,9′-diphenylfluorene, naphthalene, nitrophenylene, 4,4′-(2,2-diphenylene propane)[—C₆H₄—C(CH₃)₂—C₆H₄—]; 4,4′-(2,2-diphenylene-1,1,1,3,3,3 hexafluoropropane) [—C₆H₄—C(CF₃)₂—C₆H₄—]; triphenyl phosphine oxide; triphenyl phosphine sulfide, triphenyl phosphate, triphenyl phosphine, triphenyl ethane, triphenyl methane, and the like.

The linking structures of X₁, X₂, X₃ X₄, X₅ and X₆ are independently linking structures such as amide(—CONH—), imide((—CO—)₂N—), imidazole ((—NH—)(—N═)C—), oxazoles ((—NH—)(—O—)C—), thiazoles ((—NH—)(—S—)C—), amine (—NH—) group, ether (—O—), sulfide (—S—), sulfone (—SO₂—), and the like. It is preferred that the linking structure is independently selected from amide(—CONH—), imide((—CO—)₂N—), imidazole ((—NH—)(—N═)C—), oxazoles ((—NH—)(—O—)C—), thiazoles ((—NH—)(—S—)C—), or amine (—NH—) group.

The linking structures of Q are a fluorinated alkylene or fluorinated alkoxylene groups with carbon number from 1 to 12. Preferably Q is a perfluorinated alkylene or perfluorinated alkoxylene groups with carbon number from 1 to 9. It is also believed that a higher carbon number of Q is preferred. The alkoxylene group is an alkylene group that contains one or multiple ether linkage(s). R is a fluorinated alkyl or fluorinated alkoxy group with carbon number from 1 to 12. Preferably, R is a perfluorinated alkyl or alkoxy group with carbon number from 1 to 10. The alkoxy group is an alkyl group containing one or multiple ether linkages. It is also believed that a higher number of R is preferred.

The said polymers can be random or blocked copolymers and can be crosslinked by irradiation or when trifunctional or tetrafunctional monomers are to be used or by other means. The polymerization reaction could occur in bulk, solution, or in porous substrates or in microporous membranes. Suitable solvents are inert to the conditions encountered in the polymerization reactions. At atmospheric pressure, preferred solvents are those with normal boiling points around 150° to 300° C. or higher. Fluorinated solvents may be preferred but chlorinated solvents are also useful as well as other organic solvents such as diphenyl oxide, dimethyl sulfoxide, NMP(1-Methyl-2-pyrrolidinone) and poly(phosphoric acid) and the like. The polymerization reaction usually takes place at a temperature from about 0° C. up to 400° C. Preferably reaction temperature is in the range from 20° C. to 300° C. If the monomers or oligomers have high enough boiling points, they could be polymerized in a polymer shaping device, or for imbibing into porous or microporous substrates and cured thereafter. For instance, a polymer shaping device may include an extruder, injection mold or compression mold. Porous or microporous substrates could be selected from organic or inorganic polymeric woven or non-woven materials and microporous membranes. Suitable microporous membranes include microporous PVDF (polyvinylidene fluoride) membranes, microporous PTFE (polytetrafluoroethylene) membranes, or microporous inorganic membranes. The polymeric membranes or composite membranes with thickness ranging from 5 micrometer to 5,000 micrometer are suitable for fuel cell, electrochemical applications, or selective permeable applications. The composite membranes should contain the ionic polymer of this invention in the range of 20% to 100% by weight of the composite membranes. It is also desirable for fuel cell applications to remove all metal ions from the membranes by washing with acids, such as nitric acid, hydrogen chloride or other suitable acids.

### EXAMPLE 1

Preparation of (perfluorobutyl sulfonyl imide) 1,4-phenylenediamine ((H₂N—)₂—C₆H₃—SO₂N(K)SO₂C₄F₉)

In a 50 ml stainless steel reactor, equipped with magnetic agitator, at room temperature 25 ml of dimethyl sulfoxide and 10 grams of 2,5-dichlorobenzenesulfonyl chloride (from Aldrich Chemical) were charged to the reactor. The reactor was sealed and completely submerged in an oil bath at 400 C and the sulfonyl chloride compound was treated by excess amount of dry ammonia gas to convert it into dichlorobenzene sulfonyl amide ((Cl)₂—C₆H₃—SO₂NH₂). In the next step, excess amount of perfluorobutyl sulfonyl fluoride was added to the dichlorobenzene sulfonyl amide product with about 1% of tributylamine on weight of dichlorobenzene sulfonyl amide in the reactor. It was purged with nitrogen before sealed and heated to 80° C. for 12 hours. One reaction product obtained after purification with suitable solvents is perfluorobutyl sulfonyl imide 1,4-dichlorobenzene ((Cl)₂—C₆H₃—SO₂NHSO₂C₄F₉). The chemical structure was confirmed by NMR and infrared. The sulfonyl imide product was then neutralized by potassium hydroxide into ((Cl)₂—C₆H₃—SO₂N(K)SO₂C₄F₉). Following the amino-de-halogenation reaction taught by Heaney in Chem Rev. 1962, 62, 81-97, pp 83-89, aryl chlorides are converted to amines by the use of NaNH₂/NH₃(1). The desired product of (perfluorobutyl sulfonyl imide, potassium salt) 1,4-phenylenediamine ((H₂N—)₂—C₆H₃—SO₂N(K)SO₂C₄F₉) was obtained in good yield, also confirmed by NMR and infrared.

### EXAMPLE 2-4

Following similar procedures described above, the following desired monomers were obtained:

(perfluoromethyl sulfonyl imide, sodium salt) 1,3-phenylenediamine ((H₂N—)₂—C₆H₃—SO₂N(Na)SO₂CF₃)

Bis(perfluorobutyl sulfonyl imide, potassium salt) 4,4′-diamino biphenyl (H₂N—) C₆H₃ (SO₂N(K)SO₂C₄F₉)—C₆H₃ (SO₂N(K)SO₂C₄F₉)(—NH₂)

Bis(perfluorooctyl sulfonyl imide, lithium salt) 4,4′-diamino benzophenone (H₂N—)C₆H₃(SO₂N(Li) SO₂C₈F₁₇)—(C═O)—C₆H₃(SO₂N(Li) SO₂ C₈F₁₇)(—NH₂)

### EXAMPLE 5

Preparation of (difluoromethylene Sulfonic Acid, Sodium Salt) 1,4-phenylenediamine (H₂N—)₂—C₆H₃—CF₂SO₃Na

FSO₂CF₂COF was obtained based on the teaching by Desmarteau in U.S. Pat. No. 5,463,005. Then, following the methods taught by Sawada et al. In Bull Chem Soc Jpn 59:215 (1986), Sawada et al. In J. Fluorine Chem 46:423 (1989), Yoshida et al. In Chem Lett 1985:755 (1985), Nishida et al. in J Fluorine Chem 63:43 (1993), diacyl peroxide (FSO₂CF₂CO₂)₂ was used to add difluoromethylenesulfonyl fluoride onto the aromatic ring of 1,4-dichlorobenzene. It yields (difluoromethylene sulfonyl fluoride) 1,4-dichlorobenzene (Cl—)₂—C₆H₃—CF₂SO₂F. Furthermore, the sulfonyl fluoride functional group was hydrolyzed by sodium carbonate to yield (difluoromethylene sulfonic acid, sodium salt) 1,4-dichlorobenzene (Cl—)₂—C₆H₃—CF₂SO₃Na. Then, following the same amino-de-halogenation process in Example 1, the desired reaction products obtained and confirmed by NMR and infrared methods is (difluoromethylene sulfonic acid, sodium salt) 1,4-phenylenediamine. ((H₂N—)₂—C₆H₃—CF₂SO₃Na)

### EXAMPLE 6

Preparation of (difluoromethylene Perfluorobutyl Sulfonyl Imide, Potassium Salt) 1,4-phenylenediamine

(H₂N—)₂—C₆H₃—CF₂SO₂N(K)SO₂C₄F₉

Following the same method taught by Desmarteau in U.S. Pat. No. 5,463,005 for creating sulfonyl imide linkage, the precursor monomer of (difluoromethylene sulfonyl fluoride) 1,4-dichlorobenzene from Example 5 and perfluorobutanesulfonyl fluoride were used to produce the desired intermediate product of (difluoromethylene perfluorobutyl sulfonyl imide) 1,4-dichlorobenzene (Cl—)₂—C₆H₃—CF₂SO₂—NH—SO₂—C₄F₉ in good yield. Then, following the same amino-de-halogenation process in Example 1, the desired reaction products obtained and confirmed by NMR and infrared methods is (difluoromethylene perfluorobutyl sulfonyl imide) 1,4-phenylenediamine. ((H₂N—)₂—C₆H₃—CF₂SO₂—NH—SO₂—C₄F₉)

### EXAMPLE 7

Preparation of (3,3′,4,4′-biphenyltetramine Sulfonyl Imide, Potassium Salt) ((H₂N—)₂—C₆H₃—SO₂N(K)SO₂—C₆H₃—(—NH₂)₂)

Following the method taught by Desmarteau in U.S. Pat. No. 5,463,005 and his other publications, 3,4-dichlorobenzenesulfonyl chloride (both from Aldrich Chemical) was converted into 3,3′,4,4′-tetrachlorobiphenyl sulfonyl imide Cl₂C₆H₃SO₂NHSO₂C₆H₃Cl₂ in good yield confirmed by NMR and infrared. The sulfonyl imide was neutralized by potassium hydroxide into potassium salt Cl₂C₆H₃SO₂N(K)SO₂C₆H₃Cl₂. Following the amino-de-halogenation reaction taught by Heaney in Chem. Rev. 1962, 62, 81-97, pp 83-89, aryl chlorides were converted to amines by the use of NaNH₂/NH₃(1). The desired product of 3,3′,4,4′-biphenyltetramine sulfonyl imide, potassium salt ((H₂N—)₂—C₆H₃—SO₂N(K)SO₂—C₆H₃—(—NH₂)₂) was obtained in good yield, also confirmed by NMR and infrared.

### EXAMPLE 8

Preparation of (3,3′,4,4′-biphenyltetramine, bis(difluoromethylen)sulfonyl Imide, Potassium Salt) ((H₂N—)₂—C₆H₃—CF₂—SO₂N(K)SO₂—CF₂—C₆H₃—(—NH₂)₂)

Following the same method of Example 5, 1,2-dichlorobenzene was added a difluoromethylene sulfonyl fluoride group to yield (difluoromethylene sulfonyl fluoride) 3,4-dichlorobenzene. Then, following the method taught by Desmarteau in U.S. Pat. No. 5,463,005 and his other publications, (difluoromethylene sulfonyl fluoride) 3,4-dichlorobenzene was converted into 3,3′,4,4′-tetrachlorobiphenyl (bis(difluoromethylene) sulfonyl imide). Cl₂C₆H₃—CF₂—SO₂NHSO₂—CF₂—C₆H₃Cl₂ in good yield confirmed by NMR and infrared. The sulfonyl imide was neutralized by potassium hydroxide into potassium salt Cl₂C₆H₃—CF₂—SO₂N(K)SO₂—CF₂—C₆H₃Cl₂. Following the amino-de-halogenation reaction taught by Heaney in Chem. Rev. 1962, 62, 81-97, pp 83-89, aryl chlorides were converted to amines by the use of NaNH₂/NH₃(1). The desired product of 3,3′,4,4′-biphenyltetramine (bis(difluoromethylene) sulfonyl imide), potassium salt ((H₂N—)₂—C₆H₃—CF₂—SO₂N(K)SO₂—CF₂—C₆H₃—(—NH₂)₂) was obtained in good yield, also confirmed by NMR and infrared.

### EXAMPLE 9

Preparation of Ion-Containing Aromatic Polyimides of the Invention

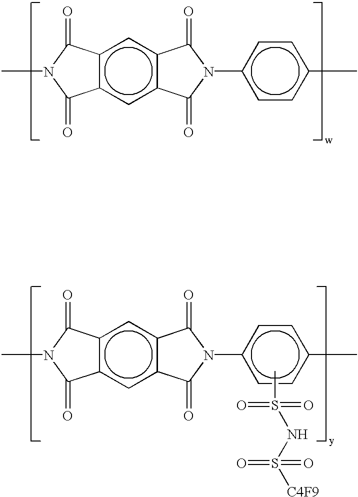

The polyimide is synthesized by the two-step polycondensation of a dianhydride and diamine in an aprotic solvent. High molecular weight five-membered ring polyimide was obtained via one-pot ester-acid procedure by initially converting the dianhydrides to diester-acid derivatives, followed by the reaction with aryl amines. 1,2,4,5-benzenetetracarboxylic dianhydride was converted to a diethyl ester-acid by reaction of ethanol with 1,2,4,5-benzenetetracarboxylic dianhydride to yield 1,2,4,5-benzenetetracarboxylic acid 1,5-diethyl ester. In a 50 ml stainless steel pressure reactor fitted with a nitrogen padded reflux condenser, mechanical stirrer and a thermocouple attached to a temperature controller are placed 20 ml NMP/o-DCB(o-dichlorobenzene)(80:20 by weight), 4 mmole of (perfluorobutyl sulfonyl imide) 1,4-phenylenediamine ((H₂N—)₂—C₆H₃—SO₂N(K)SO₂C₄F₉) and 2 mmole of 1,4-phenylenediamine and 6 mmole of 1,2,4,5-benzenetetracarboxylic acid 1,5-diethyl ester. After purging the flask with nitrogen thoroughly, the mixture was stirred and heated to 180° C. reflux for 24 hours. The reaction intermediate—polyamic acid precursors were thermally imidized in-situ using o-DCB to remove water during cyclodehydration. The polymer product was obtained in good yield. NMR analysis showed that

[—N(—CO—)₂ C₆H₂—(—CO—)₂N— C₆H₄—]_{0.33}—[—N(—CO—)₂ C₆H₂—(—CO—)₂N—C₆H₃(SO₂N(K)SO₂C₄F₉)—]_{0.67} was produced. The molecular weights of the polymer were obtained by GPC in NMP as follows:

Mn=58,000, Mw=114,000. The polymer has good thermal stability by TGA(thermal gravimetric analysis) with less than 7 weight % loss per hour at 300° C. in air.

### EXAMPLE 10-12

Separately, following the similar polymerization procedures as in Example 9, a few other copolymers were also produced in good yield as follows:

3 mmole of Bis(perfluorobutyl sulfonyl imide, potassium salt) 4,4′-diamino biphenyl (H₂N—) C₆H₃ (SO₂N(K)SO₂C4F₉)—C₆H₃ (SO₂N(K)SO₂C₄F₉) (—NH₂) was copolymerized with 3 mmole of 4,4′-diaminobiphenyl and 6 mmole of 3,3′,4,4′-benzophenonetetracarboxylic dianhydride. The copolymer was confirmed by NMR with the following structure:

[—N(—CO—)₂C₆H₃—CO—C₆H₃—(—CO—)₂N—C₆H₄C₆H₄—]_{0.5}—[—N(—CO—)₂C₆H₃—CO—C₆H₃—(—CO—)₂N—C₆H₃ (SO₂N(K)SO₂C₄F₉)—C₆H₃(SO₂N(K)SO₂C₄]F) —]_{0.5}

The molecular weights of the polymer were obtained by GPC in NMP as follows:

Mn=51,000, Mw=98,000.

2 mmole of (perfluorooctyl sulfonyl imide, lithium salt) 4,4-diamino benzophenone (H₂N—)C₆H₃(SO₂N(Li)SO₂C₈F₁₇)—(C═O)—C₆H₃(SO₂N(Li)SO₂C₈F₁₇)(—NH₂) was copolymerized with 4 mmole of 1,4-phenylenediamine and 6 mmole of 3,3′,4,4′-biphenyltetracarboxylic dianhydride. The copolymer was confirmed by NMR with the following structure:

[—N(—CO—)₂C₆H₃C₆H₃—(—CO—)₂N—C₆H₄—]_{0.67}—[—N(—CO—)₂C₆H₃C₆H₃—(—CO—)₂N—C₆H₃(SO₂N(Li)SO₂C₈F₁₇)—(C═O)—C₆H₃(SO₂N(Li)SO₂C₈F₁₇)—]_{0.33}

The molecular weights of the polymer were obtained by GPC in NMP as follows:

Mn=54,000, Mw=103,000.

5 mmole of (difluoromethylene sulfonic acid, sodium salt) 1,4-phenylenediamine

(H₂N-)₂-C₆H₃- CF₂SO₃Na was copolymerized with 1 mmole of 1,3-phenylenediamine and 6 mmole of 3,3′,4,4′-benzophenonetetracarboxylic acid dianhydride. The copolymer was confirmed by NMR with the following structure:

[—N(—CO—)₂C₆H₃—CO—C₆H₃—(—CO—)₂N—C₆H₄—]_{0.16}—[—N(—CO—)₂C₆H₃—CO—C₆H₃—(—CO—)₂N—)C₆H₃(CF₂SO₃Na)—]_{0.84}

The molecular weights of the polymer were obtained by GPC in NMP as follows:

Mn=61,000, Mw=118,000.

All three polymers have good thermal stability by TGA(thermal gravimetric analysis) with less than 8 weight % loss per hour at 300° C. in air.

### EXAMPLE 13

Preparation of Ion-Containing poly(aryl Amide) of the Invention

The poly(aryl amide) is synthesized by the one-step polycondensation of a dicarboxylic halide and diamine in an aprotic solvent. In a 50 ml stainless steel pressure reactor fitted with a nitrogen padded reflux condenser, mechanical stirrer and a thermocouple attached to a temperature controller are placed 20 ml NMP/DMSO(dimethyl sulfoxide)(50:50), 3 mmole of (perfluorobutyl sulfonyl imide) 1,4-phenylenediamine ((H₂N—)₂—C₆H₃—SO₂N(K)SO₂C₄F₉) and 3 mmole of 1,4-phenylenediamine and 6 mmole of terephthaloyl chloride (obtained from Aldrich) and 20 mmole of triethylamine. After purging the flask with nitrogen thoroughly, the mixture was stirred and heated to 180° C. reflux for 24 hours. The polymer product was obtained in good yield. NMR analysis showed that

[—NHCO—C₆H₄—CONH—C₆H₄—]_{0.5}—[—NHCO—C₆H₄—CONH—C₆H₃(SO₂N(K)SO₂C₄F₉)—]_{0.5} was produced. The polymer has good thermal stability by TGA(thermal gravimetric analysis) with less than 9 weight % loss per hour at 300° C. in air.

### EXAMPLE 14

Preparation of Ion-Containing Poly(aryl Amine) of the Invention

The poly(arylamine) is synthesized by the one-step polycondensation of a dihalide and diamine in an aprotic solvent. In a 50 ml stainless steel pressure reactor fitted with a nitrogen padded reflux condenser, mechanical stirrer and a thermocouple attached to a temperature controller are placed 20 ml NMP/DMSO(dimethyl sulfoxide)(50:50 by weight), 4 mmole of (perfluorobutyl sulfonyl imide) 1,4-phenylenediamine ((H₂N—)₂—C₆H₃—SO₂N(K)SO₂C₄F₉) and 2 mmole of 1,4-phenylenediamine and 6 mmole of 1,4-dichlorobenzene and 20 mmole of triethylamine. After purging the flask with nitrogen thoroughly, the mixture was stirred and heated to 180° C. reflux for 24 hours. The polymer product was obtained in good yield. NMR analysis showed that

[—NH—C₆H₄—NH—C₆H₄—]_{0.33}—[—NH—C₆H₄—NH—C₆H₃(SO₂N(K)SO₂C₄F₉)—]_{0.67} was produced. The molecular weights of the polymer were obtained by GPC in NMP as follows:

Mn=78,000, Mw=154,000.

### EXAMPLE 15

Preparation of Ion-Containing Poly(aryl Sulfonyl Amide) of the Invention

The poly(aryl sulfonyl amide) is synthesized by the one-step polycondensation of a disulfonyl halide and diamine in an aprotic solvent. In a 50 ml stainless steel pressure reactor fitted with a nitrogen padded reflux condenser, mechanical stirrer and a thermocouple attached to a temperature controller are placed 20 ml NMP/DMSO(dimethyl sulfoxide)(50:50), 3 mmole of (perfluorobutyl sulfonyl imide) 1,4-phenylenediamine ((H₂N—)₂—C₆H₃—SO₂N(K)SO₂C₄F₉) and 3 mmole of 1,4-phenylenediamine and 6 mmole of 1,3-benzenedisulfonyl chloride (obtained from Aldrich) and 20 mmole of triethylamine. After purging the flask with nitrogen thoroughly, the mixture was stirred and heated to 180° C. reflux for 24 hours. The polymer product was obtained in good yield. NMR analysis showed that

[—NH SO₂—C₆H₄—SO₂NH—C₆H₄—]_{0.5}—[—NHSO₂—C₆H₄—SO₂NH—C₆H₃(SO₂N(K)SO₂C₄F₉)—]_{0.5} was produced. The molecular weights of the polymer were obtained by GPC in NMP as follows:

Mn=87,000, Mw=166,000.

### EXAMPLE 16

Preparation of an Ion-Containing Poly(benzimidazole) of the Invention

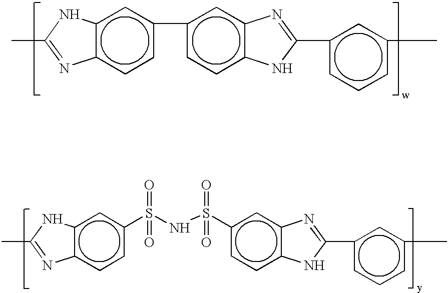

The poly(benzimidazole) can be synthesized by the one-step polycondensation of a dicarboxylic acid and a tetramine in poly(phosphoric acid). In a 200 ml stainless steel pressure reactor fitted with a nitrogen padded reflux condenser, mechanical stirrer and a thermocouple attached to a temperature controller are placed 100 ml polyphosphoric acid (obtained from Aldrich Chemical), 4 mmole of (3,3′,4,4′-biphenyltetramine sulfonyl imide, potassium salt) ((H₂N—)₂—C₆H₃—SO₂N(K)SO₂—C₆H₃—(—NH₂)₂) and 2 mmole of 3,3′,4,4′-biphenyltetramine ((H₂N—)₂—C₆H₃—C₆H₃—(—NH₂)₂) and 6 mmole of isophthalic acid (obtained from Aldrich). After purging the flask with nitrogen thoroughly, the mixture was stirred and heated to 190° C. reflux for 24 hours. The polymer product was obtained in good yield. NMR analysis showed that

[—C(═N—)(—NH—) C₆H₃—C₆H₃(—NH—)(—N═)C—C₆H₄—]_{0.33}[—C(═N—)(—NH—) C₆H₃—SO₂N(K)SO₂—C₆H₃(—NH—)(—N═)C—C₆H₄—]_{0.67} was produced. The polymer has good thermal stability by TGA (thermal gravimetric analysis) with less than 5 weight % loss per hour at 300° C. in air.

### EXAMPLE 17-18

Separately, followed the similar polymerization procedures as in Example 16, except changing the monomers, a few other aromatic poly(imidazole) were also produced in good yield as follows:

4 mmole of (3,3′,4,4′-biphenyltetramine sulfonyl imide, potassium salt) ((H₂N—)₂—C₆H₃—SO₂N(K)SO₂—C₆H₃—(—NH₂)₂) and 2 mmole of a self-condensing monomer 3,4-diaminobenzoic acid ((H₂N—)₂—C₆H₃—COOH) and 4 mmole of isophthalic acid (obtained from Aldrich). After purging the flask with nitrogen thoroughly, the mixture was stirred and heated to 190° C. reflux for 24 hours. The polymer product was obtained in good yield. NMR analysis showed that

[—C(═N—)(—NH—) C₆H₃—]0.33 [—C(═N—)(—NH—) C₆H₃—SO₂N(K)SO₂—C₆H₃(—NH—)(—N═)C—C₆H₄—]_{0.67} was produced. The polymer has good thermal stability by TGA (thermal gravimetric analysis) with less than 5 weight % loss per hour at 300° C. in air.

3 mmole of (3,3′,4,4′-biphenyltetramine, bis(difluoromethylen) sulfonyl imide, potassium salt) ((H₂N—)₂—C₆H₃—CF₂—SO₂N(K)SO₂—CF₂—C₆H₃—(—NH₂)₂) and 3 mmole of 3,3′,4,4′-biphenyltetramine ((H₂N—)₂—C₆H₃—C₆H₃—(—NH₂)₂) and 6 mmole of teraphthalic acid (obtained from Aldrich). After purging the flask with nitrogen thoroughly, the mixture was stirred and heated to 190° C. reflux for 24 hours. The polymer product was obtained in good yield. NMR analysis showed that

[—C(═N—)(—NH—) C₆H₃-C₆H₃(—NH—)(—N═)C—C₆H₄—]_{0.5}[—C(═N—)(—NH—) C₆H₃—CF₂—SO₂N(K)SO₂—CF₂—C₆H₃(—NH—)(—N═)C—C₆H₄—]_{0.5} was produced. The polymer has good thermal stability by TGA (thermal gravimetric analysis) with less than 5 weight % loss per hour at 300° C. in air.

### EXAMPLE 19

Preparation of Crosslinked Copolymer Imbibing in Poly(vinylidene Fluoride) Membrane

The polymerization reaction of Example 9 was modified, using 4 mmole of (perfluorobutyl sulfonyl imide) 1,4-phenylenediamine ((H₂N—)₂—C₆H₃—SO₂N(K)SO₂C₄F₉) and 2.15 mmole of 1,4-phenylenediamine and 6 mmole of 1,2,4,5-benzenetetracarboxylic acid 1,5-diethyl ester, and the reaction time was only 3 hours. Then, 0.1 mmole of a trifunctional monomer Tris(4-chlorophenyl)phosphine was introduced into the reaction mixture as well as 1 gram of poly(vinylidene fluoride) (obtained from Aldrich Chemical, with average Mw ca. 180,000). After further reaction for another 1 hour under reflux, solution viscosity built up. The solution was casted into a thin film and was placed in an vacuum oven at 180° C. to remove solvents while the crosslinking reaction continued. The composite membrane contains about 75% by weight of the crosslinked ionic copolymer and about 25% poly(vinylidene fluoride), which was phase separated after solvent evaporation into microporous structure. The composite membrane has a good mechanical strength at dry and humid environments. The membrane thickness is about 28 micrometer. The membrane was further repeated washed with 10% HCl solution to remove the potassium salt from the membrane, ready for fuel cell applications.

We claim:

1. High temperature ion-containing polymers having the basic molecular structure selected from
—[A₁-X₁-A₂-X₂]_{w}-[A₄-X₄-A₅-X₅-]_{y} or
-[A₃-X₃]_{w}-[A₆-X₆-]_{y} or
-[A₃-X₃]_{w}-[A₄-X₄-A₅-X₅-]_{y} or
-[A₁-X₁-A₂-X₂]_{w}-[A₆-X₆-]_{y}
wherein A₁, A₂, A₃, A₄, A₅ and A₆ are unsubstituted or inertly substituted aromatic hydrocarbyl or heterocyclic functional groups; X₁, X₂, X₃, X₄, X₅ and X₆ are linking functional groups selected from [amide(—CONH—), sulfonyl amide (—SO₂NH—), imide((—CO—)₂N—), imidazole ((—NH—)(—N═)C—), oxazoles ((—NH—)(—O—)C-), thiazoles ((—NH—)(—S—)C—), amino (—NH—) group, ether (—O—), sulfide (—S—), sulfone (—SO₂—)]; w is from 0 to 90 molar %; y is from 10 to 100 molar %; while A₁, A₂ and A₃ do not contain any ionic functional group, A₆ and A₄ or A₅ must contain at least one ionic functional group selected from the following:
(a) pendent ionic group:
-Q-SO₃(M), or
-Q-SO₂—N(M)—SO₂—R, or
—SO₂—N(M)—SO₂—R
(b) linking ionic group:
—SO₂—N(M)-SO₂— or
—Q-SO₂—N(M)—SO₂— or
-Q-SO₂—N(M)—SO₂-Q-
wherein Q is a fluorinated alkylene or fluorinated alkoxylene group with carbon number from 1 to 12; R is a fluorinated alkyl or fluorinated alkoxy group with carbon number from 1 to 12; M can be hydrogen H, lithium Li, sodium, Na, potassium K, and other suitable metal ions or organic bases; When A₆ and A₄ or A₅ contains the linking ionic group of (b), it contains at least 2 aromatic rings that connect to each side of the linking ionic group respectively.

2. The polymer of claim 1 wherein it is crosslinked.

3. The structure A₁, A₂, A₃, A₄, A₅ and A₆ of claim 1 wherein they can be any molecular structure having aromatic character or heterocyclic structure, preferably having at least one five membered ring or six membered aromatic ring, or suitably having 2 to 6 of such rings fused together or connected by bonds or linking structures.

4. The structure A₁, A₂, A₃, A₄, A₅ and A₆ of claim 3 wherein the aromatic molecular structure includes perchlorophenylene, perfluorophenylene, phenylene, biphenylene, oxydiphenylene, thiodiphenylene, phenyl sulfone, benzophenone, benzophenone imine, furan, pyridine, pyrrole, thiophene, 9,9′-diphenylfluorene, naphthalene, nitrophenylene, 4,4′-(2,2-diphenylene propane)[—C₆H₄—C(CH₃)₂—C₆H₄—]; 4,4′-(2,2-diphenylene-1,1,1,3,3,3 hexafluoropropane) [—C₆H₄—C(CF₃)₂—C₆H₄—]; triphenyl phosphine oxide; triphenyl phosphine sulfide, triphenyl phosphate, triphenyl phosphine, triphenyl ethane, and triphenyl methane.

5. The linking structures X₁, X₂, X₃, X₄, X₅ and X₆ of claim 1 wherein they are independently linking structures selected from from amide(—CONH—), sulfonyl amide (—SO₂NH—), imide((—CO—)₂N—), imidazole ((—NH—)(—N═)C—), oxazoles ((—NH—)(—O—)C—), thiazoles ((—NH—)(—S—)C—), amino (—NH—) group, ether (—O—), sulfide (—S—), and sulfone (—SO₂—) or any combination of them.

6. The linking structure X₁, X₂, X₃, X₄, X₅ and X₆ of claim 5 wherein they are independently selected from amide(—CONH—), imide((—CO—)₂N—), imidazole ((—NH—)(—N═)C—), oxazoles ((—NH—)(—O—)C—), thiazoles ((—NH—)(—S—)C—), or amino (—NH—) group.

7. The linking structure Q of claim 1 wherein it is a perfluorinated alkylene or perfluorinated alkoxylene groups with carbon number from 1 to 9.

8. The linking structure R of claim 1 wherein it is a perfluorinated alkyl or alkoxy group with carbon number from 1 to 10.

9. The polymer of claim 1 wherein it is a membrane with thickness ranging from 5 to 5,000 micrometer, suitable for fuel cell, electrochemical applications, and selective permeable applications.

10. The polymer of claim 1 wherein it is imbibed into porous substrates or microporous membranes to form composite substrates or composite membranes.

11. The microporous membranes of claim 10 wherein it includes those made of poly(vinylidene fluoride), poly(tetrafluoroethylene), and other organic or inorganic materials.

12. The polymer of claim 1 wherein it is aromatic polyimide containing at least one ionic functional group selected from the following:
(a) pendent ionic group:
-Q-SO₃(M), or
-Q-SO₂—N(M)—SO₂—R, or
—SO₂—N(M)—SO₂—R
(b) linking ionic group:
—SO₂—N(M)—SO₂— or
-Q-SO₂—N(M)—SO₂— or
-Q-SO₂—N(M)—SO₂-Q-
wherein Q is a fluorinated alkylene or fluorinated alkoxylene group with carbon number from 1 to 12; R is a fluorinated alkyl or fluorinated alkoxy group with carbon number from 1 to 12; M can be hydrogen H, lithium Li, sodium, Na, potassium K, and other suitable metal ions or organic bases;
When A₆ and A₄ or A₅ contains the linking ionic group of (b), it contains at least 2 aromatic rings that connect to each side of the linking ionic group respectively.

13. The polymer of claim 1 wherein it is aromatic poly(imidazole) containing at least one ionic functional group selected from the following:
(a) pendent ionic group:
-Q-SO₃(M), or
-Q-SO₂—N(M)—SO₂—R, or
—SO₂—N(M)—SO₂—R
(b) linking ionic group:
—SO₂—N(M)—SO₂— or
-Q-SO₂—N(M)—SO₂— or
-Q-SO₂—N(M)—SO₂-Q-
wherein Q is a fluorinated alkylene or fluorinated alkoxylene group with carbon number from 1 to 12; R is a fluorinated alkyl or fluorinated alkoxy group with carbon number from 1 to 12; M can be hydrogen H, lithium Li, sodium, Na, potassium K, and other suitable metal ions or organic bases;
When A₆ and A₄ or A₅ contains the linking ionic group of (b), it contains at least 2 aromatic rings that connect to each side of the linking ionic group respectively.

14. The polymer of claim 1 wherein it is aromatic polyamine containing at least one ionic functional group selected from the following:
(a) pendent ionic group:
-Q-SO₃(M), or
-Q-SO₂—N(M)—SO₂—R, or
—SO₂—N(M)—SO₂—R
(b) linking ionic group:
—SO₂—N(M)—SO₂— or
-Q-SO₂—N(M)—SO₂— or
-Q-SO₂—N(M)—SO₂-Q-
wherein Q is a fluorinated alkylene or fluorinated alkoxylene group with carbon number from 1 to 12; R is a fluorinated alkyl or fluorinated alkoxy group with carbon number from 1 to 12; M can be hydrogen H, lithium Li, sodium, Na, potassium K, and other suitable metal ions or organic bases;
When A₆ and A₄ or A₅ contains the linking ionic group of (b), it contains at least 2 aromatic rings that connect to each side of the linking ionic group respectively.

15. The polymer of claim 1 wherein it is aromatic polyamide containing at least one ionic functional group selected from the following:
(a) pendent ionic group:
-Q-SO₃(M), or
-Q-SO₂—N(M)—SO₂—R, or
—SO₂—N(M)—SO₂—R
(b) linking ionic group:
—SO₂—N(M)—SO₂— or
-Q-SO₂—N(M)—SO₂— or
-Q-SO₂—N(M)—SO₂-Q-
wherein Q is a fluorinated alkylene or fluorinated alkoxylene group with carbon number from 1 to 12; R is a fluorinated alkyl or fluorinated alkoxy group with carbon number from 1 to 12; M can be hydrogen H, lithium Li, sodium, Na, potassium K, and other suitable metal ions or organic bases;
When A₆ and A₄ or A₅ contains the linking ionic group of (b), it contains at least 2 aromatic rings that connect to each side of the linking ionic group respectively.

16. Polymers prepared by polymerization of the monomer mixture selected from:
0-90 molar % of [monomer pair of A1(Y₁)ₚ and A₂ (Y₂)_{q}] or [self-condensing monomer A₃ (Y₁)ₚ (Y₂)_{q}]
10-100 molar % of [monomer pair of A₄ (Y₃)ₚ and A₅ (Y₄)_{q}] or [self-condensing monomer A₆ (Y₃)ₚ (Y₄)_{q}]
wherein Y₁, Y₂, Y₃ and Y₄ are reactive functional groups that can chemically react with at least one another and are selected from [amine (—NH₂), anhydride ((—CO—)₂O), imide ((—CO—)₂NH), amide (—CONH₂), sulfonyl amide (—SO₂NH₂), carboxylic acid (—COOH), carboxylic acid ester, carboxylic acid halide, hydroxyl (—OH), thio (—SH), sulfonyl halide or halides, including halogen atoms such as F, Cl, Br, I]; and p and q are integers from 1 to 4; A₁, A₂ and A₃ are unsubstituted or inertly substituted aromatic hydrocarbyl group or heterocyclic functional groups that do not contain any ionic functional group; A₄, A₅ and A₆ are unsubstituted or inertly substituted aromatic hydrocarbyl groups or heterocyclic functional groups in which A₆ and A₄ or A₅ must contain at least one ionic functional group selected from the following groups
(a) pendent ionic group:
-Q-SO₂F
-Q-SO₃(M), or
-Q-SO₂—N(M)—SO₂—R, or
—SO₂—N(M)—SO₂—R
(b) linking ionic group:
—SO₂—N(M)—SO₂—
-Q-SO₂—N(M)—SO₂—
-Q-SO₂—N(M)—SO₂-Q-
wherein Q is a fluorinated alkylene or fluorinated alkoxylene group with carbon number from 1 to 12; R is a fluorinated alkyl or fluorinated alkoxy group with carbon number from 1 to 12; M can be hydrogen H, lithium Li, sodium, Na, potassium K, and other suitable metal ions or organic bases;
When A₆, A₄ or A₅ contains the linking ionic group of (b), it contains at least 2 aromatic rings that connect to each side of the linking ionic group respectively.

17. The structure A₁, A₂, A₃, A₄, A₅ and A₆ of claim 16 wherein they can be any molecular structure having aromatic character or heterocyclic structure, preferably having at least one five membered ring or six membered aromatic ring, or suitably having 2 to 6 of such rings fused together or connected by bonds or linking structures.

18. The structure A₁, A₂, A₃, A4, A₅ and A₆ of claim 16 wherein the aromatic molecular structure includes perchlorophenylene, perfluorophenylene, phenylene, biphenylene, oxydiphenylene, thiodiphenylene, phenyl sulfone, benzophenone, benzophenone imine, furan, pyridine, pyrrole, thiophene, 9,9′-diphenylfluorene, naphthalene, nitrophenylene, 4,4′-(2,2-diphenylene propane)[—C₆H₄—C(CH₃)₂—C₆H₄—]; 4,4′-(2,2-diphenylene-1,1,1,3,3,3 hexafluoropropane) [—C₆H₄—C(CF₃)₂—C₆H₄—]; triphenyl phosphine oxide; triphenyl phosphine sulfide, triphenyl phosphate, triphenyl phosphine, triphenyl ethane, and triphenyl methane.

19. The polymer of claim 16 wherein it is a membrane with thickness ranging from 5 to 5,000 micrometer, suitable for fuel cell, electrochemical applications, and selective permeable applications.

20. The polymer of claim 16 wherein it is imbibed into porous substrates or microporous membranes to form composite substrates or composite membranes.
